(19) United States
(12) Patent Application Publication
(10) Pub. No.: US 2014/0068952 A1
(43) Pub. Date: Mar. 13, 2014

(54) DUAL OSCILLATING MULTI-TOOL SAW

(71) Applicants: Robert Soreo, Cleveland Heights, OH (US); Marc Vitantonio, South Russell, OH (US); Trevor Jackson, Kirtlandf, OH (US); John Nottingham, Bratenahl, OH (US); John Spirk, Gates Mills, OH (US); Donald C. Fuchs, Jr., Mentor, OH (US)

(72) Inventors: Robert Soreo, Cleveland Heights, OH (US); Marc Vitantonio, South Russell, OH (US); Trevor Jackson, Kirtlandf, OH (US); John Nottingham, Bratenahl, OH (US); John Spirk, Gates Mills, OH (US); Donald C. Fuchs, Jr., Mentor, OH (US)

(73) Assignee: Infusion Brands, Inc., Clearwater, FL (US)

(21) Appl. No.: 14/112,556

(22) PCT Filed: Apr. 19, 2012
(86) PCT No.: PCT/US12/34168

§ 371 Date: Dec. 2, 2013

Related U.S. Application Data
(60) Provisional application No. 61/477,805, filed on Apr. 21, 2011.

(51) Int. Cl. B27B 19/00; B23D 51/16

(52) U.S. Cl. CPC B27B 19/008; B23D 51/16
USPC 30/369; 173/214

(57) ABSTRACT

An oscillating multi-tool for cutting, scraping, sanding, or grinding of material. The oscillating multi-tool includes a body, a drive system and a gear arrangement. The drive system and the gear arrangement are designed to cause first and second tool attachments to partially or fully oscillate in opposite directions. The gear arrangement is connected or interconnected to first and second tool connectors. The first tool attachment is connected to the first tool connector and the second tool attachment is connected to the second tool connector. The gear arrangement causes the first and second tool connectors to move when the drive system is activated to thereby cause the first and second tool attachments to partially or fully oscillate in opposite directions relative to one another.

The present invention claims priority on U.S. Provisional Application Ser. No. 61/477,805 filed Apr. 21, 2011, which is incorporated herein by reference.

The present invention is related to cutting, scraping, sanding, and grinding devices, particularly directed to power tools, more particularly directed to oscillating power tools, still more particularly to oscillating power tool saws that can independently oscillate at least two tool attachments, and still yet more particularly to oscillating power tool saws that can simultaneously and independently oscillate at least two tool attachments in opposite directions to one another during the use of the power tool.

### BACKGROUND OF THE INVENTION

Oscillating multi-tools are known in the art and used to cut, scrape, sand, etc. many types of materials. Various tool attachments (e.g., E-cut blade, scraper blade, sanding pad, wood saw blade, wood/metal saw blade, grout blade, plunge blade, segmented blade, etc.) can be connected to the oscillating multi-tool. The tool attachments that are connected to the oscillating multi-tool are designed to oscillate back and forth during the operation of the oscillating multi-tool. Most oscillating multi-tools are driven by an electric motor. A rotating shaft or cam is generally used to cause the tool attachments to oscillate back and forth. The rotating motion generated by the motor is then translated into an oscillating motion to move each type of tool attachment that is connected to the oscillating multi-tool.

Several non-limiting prior art oscillating multi-tools are illustrated in U.S. Pat. Nos. 2,350,098; 5,441,450; 5,482,499; 5,491,896; 5,554,066; 5,597,347; 5,607,343; 5,637,034; 5,709,595; 5,743,791; 5,759,094; 5,885,146; 5,919,085; 6,042,460; 6,062,960; 6,099,397; 6,132,300; 6,159,084; 6,179,696; 6,257,969; 6,316,890; 6,569,002; 6,736,711; 6,926,595, 7,108,077; 7,695,352; 7,854,649; 8,096,856; 8,109,809; and 8,113,520; and United States Patent Publication Nos. 2003/0220058; 2005/0126802; 2008/0169114; 2008/0190259; 2008/0232846; 2009/0308213; 2009/0311952; 2010/0003906; 2010/0186980; 2010/0193209; 2010/0210194; and 2011/0227300, all of which are incorporated herein by reference.

Although this type of oscillating multi-tool is effective for many applications, there are several disadvantages to the use of such a device. One disadvantage is that the oscillation of the tool connected to the oscillating multi-tool causes the oscillating multi-tool to move from side to side during the cutting, scraping, sanding, grinding, etc. of material by the oscillating multi-tool, thus making it difficult to hold the oscillating multi-tool in the proper position during the use of the oscillating multi-tool. Also, such movement of the oscillating multi-tool can increase the rate of fatigue on the user to properly hold and position the oscillating multi-tool during the use of the oscillating multi-tool.

In view of the current state of the art regarding oscillating multi-tools, there is a need for an improved oscillating multi-tool that reduces the side to side oscillating force, vibration and jerking actions caused by the tool on the oscillating multi-tool blade during the use of the oscillating multi-tool, reduces fatigue to the user when using the oscillating multi-tool, and improves accuracy of the cutting, scraping, sanding and/or grinding operation when using the oscillating multi-tool.

### SUMMARY OF THE INVENTION

The present invention is directed to an oscillating multi-tool that addresses the past deficiencies of prior art oscillating multi-tools. Generally, the oscillating multi-tools include two tool attachments; however, it can be appreciated that the oscillating multi-tools can be designed to include more than two tool attachments, or be used with a single tool attachment. The size, shape, configuration and/or material of the oscillating multi-tools are non-limiting. The one or more tool attachments used on the oscillating multi-tool can have the same size, shape, and/or configuration; however, this is not required. The present invention is directed to an oscillating multi-tool, more particularly directed to an oscillating multi-tool that can include a plurality of tool attachments that can be moved independently of one another, and still more particularly to an oscillating multi-tool that includes two tool attachments that can be simultaneously moved in opposite direction to one another during the operation of the oscillating multi-tool. Prior art oscillating multi-tools generally included a single tool attachment that oscillated in a side to side motion. The present invention pertains to the concept of including two tool attachments that can be oscillated together in opposite direction from one another during the use of the oscillating multi-tool. The present invention contemplates a power tool that is dedicated for use with one or more oscillating tool attachments. The ability to oscillate two tool attachments in opposite directions from one another during the use of the oscillating multi-tool can result in 1) improved cutting, scraping, sanding, grinding, etc. of material by the oscillating multi-tool, 2) reduce the vibration caused by the cutting, scraping, sanding, grinding, etc. of material by the oscillating multi-tool, 3) reduced fatigue to the user when cutting, scraping, sanding, grinding, etc. of material by the oscillating multi-tool, 4) increased ease, quality and/or accuracy of cutting, scraping, sanding, grinding, etc. of material by the oscillating multi-tool, 5) improved speed and/or accuracy of the cutting, scraping, sanding, grinding, etc. of material by the oscillating multi-tool, 6) a reduction of the side to side forces on the user when using the oscillating multi-tool and thereby reduce fatigue to the user when using the oscillating multi-tool and/or facilitate in the ease, quality and/or accuracy of cutting, scraping, sanding, grinding, etc. of material during the use of the oscillating multi-tool, 7) a reduction of the jerking actions caused by the tool attachments on the oscillating multi-tool during the cutting, scraping, sanding, grinding, etc. of material by the oscillating multi-tool and thereby reduce fatigue to the user when using the oscillating multi-tool and/or facilitate in the ease, quality and/or accuracy of cutting, scraping, sanding, grinding, etc. of material during the use of the oscillating multi-tool, and/or 8) improvements in the accuracy of cutting, scraping, sanding, grinding, etc. of material during the use of the oscillating multi-tool.

In one non-limiting aspect of the present invention, the tool attachments for the oscillating multi-tool are caused to oscillate in opposite direction to one another during the cutting, scraping, sanding, grinding, etc. of material during the use of the oscillating multi-tool. The speed or rate of oscillation of the two tool attachments, when oscillating in opposite directions, can be the same or different. In one non-limiting aspect of the invention, the speed or rate of oscillation of the two tool attachments when oscillating in opposite directions can be the same.

In another and/or alternative non-limiting aspect of the present invention, the two tool attachments can have the same or different configuration; however, this is not required. In one non-limiting embodiment of the invention, when the tool attachment is a cutting blade or scraping blade, the material, length, size and/or configuration of the two cutting blades or scraping blades are the same; however, this is not required. In another and/or alternative non-limiting embodiment of the invention, the tooth location of the two cutting blades or scraping blades, when such blades have teeth, is the same; however, this is not required. Generally, the tooth location is on the front edge of the cutting blade or scraping blade; however, it can be appreciated that the teeth can be positioned on other or additional locations on the cutting blade or scraping blade; however, this is not required. In still another and/or alternative non-limiting embodiment of the invention, the shape of the two cutting blades or scraping blades is the same; however, this is not required. When the length, tooth location and/or shape of the two cutting blades or scraping blades are the same, the two cutting blades or scraping blades can be interchangeable with one another without affecting the operation of the oscillating multi-tool; however, this is not required. In yet another and/or alternative non-limiting embodiment of the invention, the connection arrangement of the two tool attachments on the oscillating multi-tool can be the same or different. When the two tool attachments have the same connection arrangement, either tool attachment can be connected to the first or second tool connection arrangement without affecting the operation of the oscillating multi-tool; however, this is not required. When the two tool attachments have a different connection arrangement, one tool attachment can be designed to connect only to one of the tool connection arrangements and the other tool attachment can be designed to connect only to the other tool connection arrangement; however, this is not required.

In still another and/or alternative non-limiting aspect of the present invention, the oscillating multi-tool can optionally include a quick connect/release arrangement for one or both tool attachments; however, this is not required. The configuration of the quick connect/release arrangement, when included on the oscillating multi-tool, is non-limiting. In one non-limiting configuration, this is provided on one or more depressible buttons on the oscillating multi-tool to enable one or both tool attachments to be connected to and/or released from the tool connection arrangement on the oscillating multi-tool. The location of the one or more buttons on the oscillating multi-tool is non-limiting. As can be appreciated, one or more of the tool attachments can be connected to the tool connection arrangement on the oscillating multi-tool by use of a screw, a hex bolt, etc.

In yet another and/or alternative non-limiting aspect of the present invention, the oscillating multi-tool is a dedicated tool for use with one or more tool attachments. The oscillating multi-tool can be battery powered and/or powered by an AC current power cord. In one non-limiting embodiment, when two tool attachments are connected to the oscillating multi-tool, the oscillating multi-tool includes gearing that enables the two tool attachments to oscillate in opposite directions; however, this is not required. The oscillating multi-tool can include gearing that enables the two tool attachments to be oscillated in opposite directions at the same or different speeds. In another and/or alternative non-limiting embodiment of the invention, the oscillating multi-tool can include one or more optional features such as, but not limited to, a “continuous on” button, a button to activate a light or laser, a level indicator, a speed controller, a “lock off” button, battery-powered motor, rechargeable battery, removable battery, vibration reducing hand grip, reduced slip hand grip, tiltable handle, rotatable handle, speed control button, etc.; however, this is not required.

In another and/or alternative non-limiting aspect of the present invention, the oscillating multi-tool can optionally include a laser or light switch to activate and/or deactivate one or more lights or lasers on the oscillating multi-tool. The location of the switch and one or more lasers and/or lights on the oscillating multi-tool is non-limiting. When one or more lasers and/or lights are included on the oscillating multi-tool, at least one laser and/or light is generally located at the front or front portion of the oscillating multi-tool to 1) illuminate a region about the oscillating one or more tool attachments to facilitate in the illumination of the region to be cut, scraped, sanded, ground, etc. cut by the one or more tool attachments, and/or 2) create a guide line or guide region to facilitate in guiding the one or more tool attachments along the material to be cut, scraped, sanded, ground, etc. cut by the one or more tool attachments; however, this is not required. In one non-limiting arrangement, the laser or light switch is located on a region of the oscillating multi-tool that is grasped by the user (e.g., handle, etc.) when using the oscillating multi-tool; however, this is not required. The laser or light switch can be designed to be a depressible or contact switch that automatically causes one or more laser and/or lights to illuminate when the oscillating multi-tool is grasped by the user during use of the oscillating multi-tool; however, this is not required. In such an arrangement, the switch can be located on top of or hidden beneath an outer surface (e.g., soft outer surface grip, etc.) of the oscillating multi-tool.

In still another and/or alternative non-limiting aspect of the present invention, the two tool attachments can optionally include a connector arrangement that connects the two tool attachments together and enables the two tool attachments to oscillate in opposite directions during the use of the oscillating multi-tool. The configuration of the connection arrangement is non-limiting. In one non-limiting arrangement, the connection arrangement includes a pin and slot arrangement wherein one of the tool attachments includes a slot and the other tool attachment includes a pin that is designed to be moveable in the slot of the other tool attachment. The pin may have a larger head (e.g., cone shaped head, etc.) to retain the pin to the slot in the tool attachment during the oscillation of the two tool attachments; however, this is not required. The connection arrangement, when used, can be designed to facilitate in maintaining the spacing of the two tool attachments from each other during the operation of the oscillating multi-tool; however, this is not required.

In yet another and/or alternative non-limiting aspect of the present invention, the oscillating multi-tool optionally includes a gearing arrangement that includes an armature that includes one or more eccentric bearing surfaces to enable two tool attachments to oscillate in opposite directions during the operation of the oscillating multi-tool. As can be appreciated, the gearing arrangement can include other arrangements that are absent an armature that includes one or more eccentric bearing surfaces to enable two tool attachments to oscillate in opposite directions during the operation of the oscillating multi-tool.

In still another and/or alternative non-limiting aspect of the present invention, the oscillating multi-tool can include one or more of the following features and/or advantages:
The oscillating multi-tool can be used with one or more tool attachments that oscillate during the use of the oscillating multi-tool.
The one or more tool attachments can be used to cut, scrape, sand or grind material during the oscillation of the one or more tool attachments by the oscillating multi-tool.
The oscillating multi-tool can be used with different shaped and/or sized tool attachments, which different tool attachments can be designed for special uses (i.e., cutting, scraping, sanding or grinding of material).
The tool attachments on the oscillating multi-tool can be designed to oscillate in opposite directions during the use of the oscillating multi-tool.
The tool attachments on the oscillating multi-tool can result in an opposed force to thereby balance the action of the oscillating multi-tool.
The tool attachments can be designed to improve accuracy of operation and use, provide smoother operation on workpieces, and/or reduce fatigue on the user during the use of the oscillating multi-tool.
The oscillating multi-tool can be designed to enable a user to attach or remove one or more tool attachments from the tool connection arrangement on the oscillating multi-tool.
The oscillating multi-tool can be made from a variety of materials, including but not limited to metal, plastic, aluminum or recyclable material.
The oscillating multi-tool can be designed to include a rotating handle.
The oscillating multi-tool can be designed to include a pivoting handle.
The oscillating multi-tool can be designed to be a handheld tool.
The oscillating multi-tool can be designed to include one or more electric motors.
The oscillating multi-tool can be designed to include one or more tool attachments that include one or more separators to maintain the spacing of the tool attachments from one another during the operation of the oscillating multi-tool.
The oscillating multi-tool can be designed to include one or more tool attachments that include one or more connectors to connect the tool attachments together during the operation of the oscillating multi-tool.
The oscillating multi-tool can be a powered oscillating multi-tool having a counter-oscillating cutting mechanism to enable a set of stacked saw bits and related attachments (standard to oscillating multi-tools) to oscillate in opposition to each other at the same time.
The oscillating multi-tool can include a gearbox mechanism to allow for an opposed oscillating motion at various speeds.
The oscillating multi-tool that causes two tool attachments tn oscillate in opposite directions so as to partially or fully oppose the cutting, sanding, scraping and/or grinding force with each other, and balance the operation action of the oscillating multi-tool.
The oscillating multi-tool can include various styles of tool attachments that are designed for specific cutting, sanding, scraping and/or grinding purposes.

It is one non-limiting object of the present invention to provide an oscillating tool that can simultaneously oscillate two tool attachments.

It is another and/or alternative non-limiting object of the present invention to provide an oscillating multi-tool wherein two or more tool attachments oscillate in the opposite direction from one another.

It is still another and/or alternative non-limiting object of the present invention to provide an oscillating multi-tool that is dedicated to the use with one or more tool attachments.

It is yet another and/or alternative non-limiting object of the present invention to provide an oscillating multi-tool that improves the cutting, sanding, scraping and/or grinding of material by the tool attachments on the oscillating multi-tool.

It is still yet another and/or alternative non-limiting object of the present invention to provide an oscillating multi-tool that reduces the vibration caused by the cutting, sanding, scraping and/or grinding of material by the tool attachments on the oscillating multi-tool and/or operation of the oscillating multi-tool and thereby reduce fatigue to the user when using the oscillating multi-tool and/or facilitate in the ease, quality and/or accuracy of the oscillating multi-tool.

It is another and/or alternative non-limiting object of the present invention to provide an oscillating multi-tool that improves in the speed and/or accuracy of cutting, sanding, scraping and/or grinding of material during the use of the oscillating multi-tool.

It is still another and/or alternative non-limiting object of the present invention to provide an oscillating multi-tool that reduces the side to side forces on the user when using the oscillating multi-tool to cut, sand, scrape and/or grind material and thereby reduce fatigue to the user when using the oscillating multi-tool and/or facilitate in the ease, quality and/or accuracy of cutting, sanding, scraping and/or grinding of material during the use of the oscillating multi-tool.

It is yet another and/or alternative non-limiting object of the present invention to provide an oscillating multi-tool that reduces the jerking actions caused by the oscillation of the tool attachments during cutting, sanding, scraping and/or grinding of material during the use of the oscillating multi-tool and thereby reduce fatigue to the user when using the oscillating multi-tool and/or facilitate in the ease, quality and/or accuracy of cutting, sanding, scraping and/or grinding of material during the use of the oscillating multi-tool.

It is still yet another and/or alternative non-limiting object of the present invention to provide an oscillating multi-tool that improves in the accuracy of the cutting, sanding, scraping and/or grinding of material during the use of the oscillating multi-tool.

It is another and/or alternative non-limiting object of the present invention to provide an oscillating multi-tool that provides for a smoother cutting, sanding, scraping and/or grinding of material during the use of the oscillating multi-tool.

It is still another and/or alternative non-limiting object of the present invention to provide an oscillating multi-tool wherein the speed or rate of oscillation of the one or more tool attachments can be adjustable or constant.

It is yet another and/or alternative non-limiting object of the present invention to provide an oscillating multi-tool wherein the speed or rate of oscillation of two tool attachments when oscillating in opposite directions can be the same or different.

It is still yet another and/or alternative non-limiting object of the present invention to provide an oscillating multi-tool wherein the two tool attachments connected to the oscillating multi-tool have the same shape and size.

It is another and/or alternative non-limiting object of the present invention to provide an oscillating multi-tool wherein the connection arrangement of the two tool attachments to the oscillating multi-tool can be the same or different.

It is still another and/or alternative non-limiting object of the present invention to provide an oscillating multi-tool that includes a quick connect/release arrangement for one or both tool attachments from the oscillating multi-tool.

It is yet another and/or alternative non-limiting object of the present invention to provide an oscillating multi-tool that includes gearing that enables the two tool attachments to oscillate in opposite directions at the same or different speeds.

It is still yet another and/or alternative non-limiting object of the present invention to provide an oscillating multi-tool that includes a laser or light switch to activate and/or deactivate one or more lights or lasers on the oscillating multi-tool.

It is another and/or alternative non-limiting object of the present invention to provide an oscillating multi-tool that includes a connector arrangement that connects the two tool attachments together and enables the two tool attachments to oscillate in opposite directions when connected to the oscillating multi-tool and connected together by the connector arrangement.

It is still another and/or alternative non-limiting object of the present invention to provide an oscillating multi-tool that includes a gearing arrangement that includes an armature that includes one or more eccentric bearing surfaces to enable two tool attachments to oscillate in opposite directions during the operation of the oscillating multi-tool.

It is yet another and/or alternative non-limiting object of the present invention to provide an oscillating multi-tool that includes a handle that can be pivoted and/or rotated relative to the longitudinal axis of the body of the oscillating multi-tool.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various preferred embodiments that the invention may take in physical form and in certain parts and arrangement of parts wherein:

FIG. 1 is a perspective view of one non-limiting oscillating multi-tool in accordance with the present invention;

FIG. 2 is a side view of the oscillating multi-tool of FIG. 1;

FIG. 3 is an enlarged view of the front end of the oscillating multi-tool of FIG. 1 which illustrates one non-limiting arrangement for a connector arrangement for the tool attachments;

FIG. 4 is an enlarged sectional view of the front end of the oscillating multi-tool of FIG. 3 which illustrates a cut out cross-section of the connector arrangement;

FIG. 5 is a perspective view of the oscillating multi-tool of FIG. 1 without the body housing;

FIG. 6 is an exploded view of the oscillating multi-tool of FIG. 1;

FIG. 7 is an enlarged front view of the armature of the oscillating multi-tool of FIG. 1;

FIG. 8 is a perspective view of another non-limiting oscillating multi-tool in accordance with the present invention which includes a different connector arrangement for the tool attachments; and,

FIG. 9 is an enlarged sectional view of the front end of the oscillating multi-tool of FIG. 8 which illustrates a cut out cross-section of the connector arrangement.

### DETAILED DESCRIPTION OF NON-LIMITING EMBODIMENTS

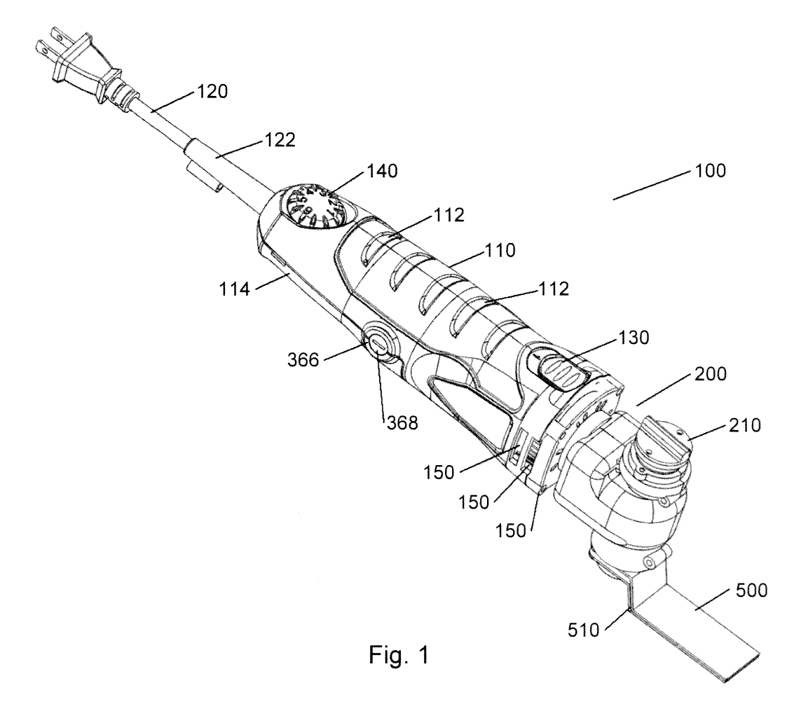

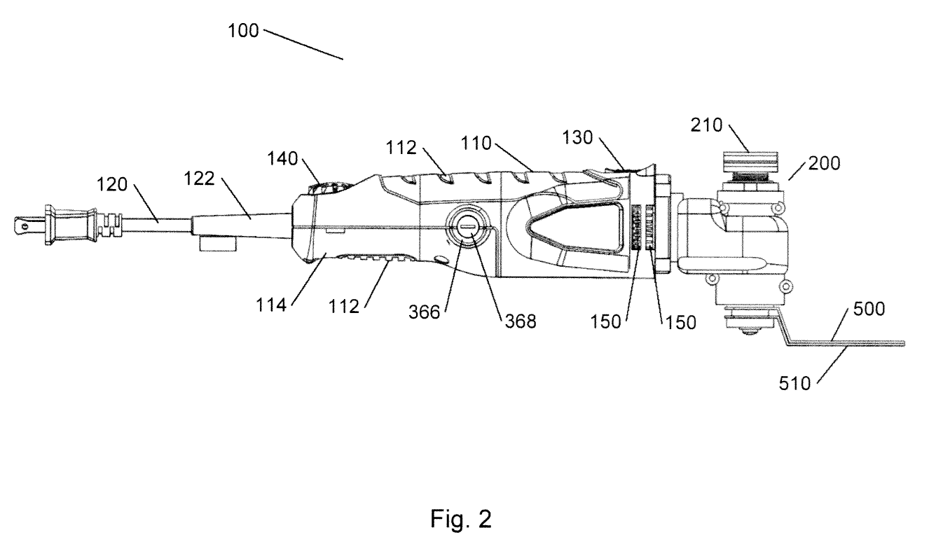

Referring now to the drawings wherein the showings are for the purpose of illustrating non-limiting embodiments of the invention only and not for the purpose of limiting same, FIGS. 1-9 illustrate non-limiting embodiments of the oscillating multi-tool in accordance with the present invention.

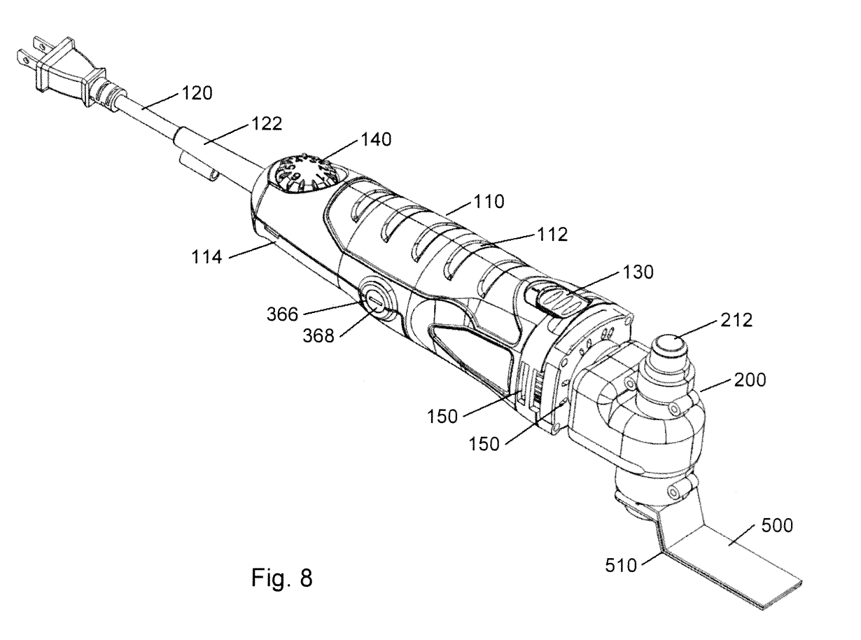

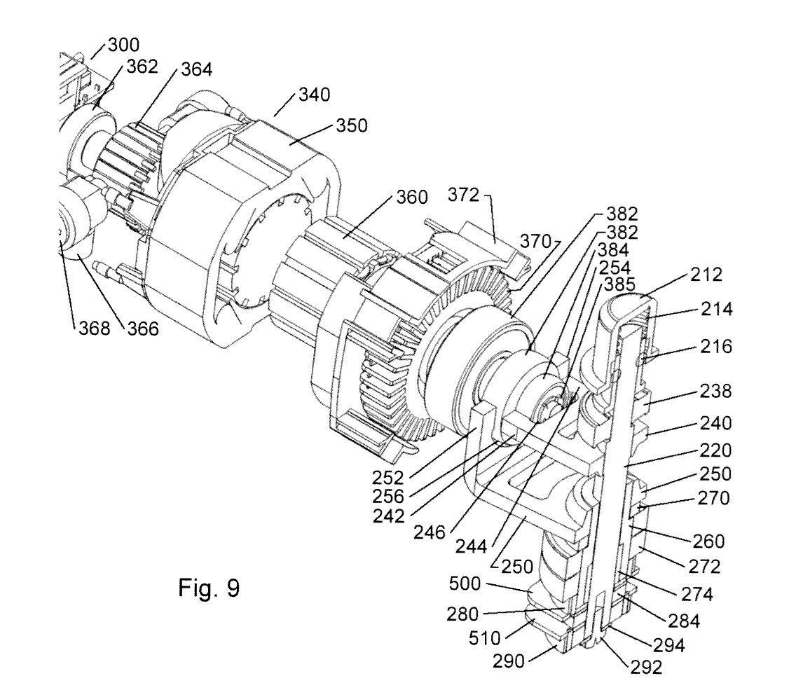

FIGS. 1-7 illustrate one non-limiting oscillating multi-tool in accordance with the present invention. FIGS. 8-9 illustrate another non-limiting oscillating multi-tool in accordance with the present invention. The oscillating multi-tool illustrated in FIGS. 8-9 is substantially the same as the oscillating multi-tool illustrated in FIGS. 1-7 except that the connector arrangement for the tool attachments in FIGS. 8-9 is slightly different from the connector arrangement for the tool attachments illustrated in FIGS. 1-7.

Referring now to FIGS. 1-7, there is illustrated an oscillating multi-tool having a body 110 in accordance with the present invention. The shape of the body of the oscillating multi-tool 100 is non-limiting. As can be appreciated, the color of the oscillating multi-tool and the materials used to make the oscillating multi-tool are non-limiting. The body 110 can be formed of one or more parts. When the body is formed of more than one part, the parts can be connected together by a variety of means (e.g., adhesive, solder bond, melt bond, weld bead, rivet, screw, nut and bolt, snap lock arrangement, clamp arrangement, etc.). As illustrated in FIGS. 1-7, oscillating multi-tool 100 is designed to be a handheld power tool; however, it can be appreciated that oscillating multi-tool 100 can be designed to be secured to a robotic or fixed to some type of machine.

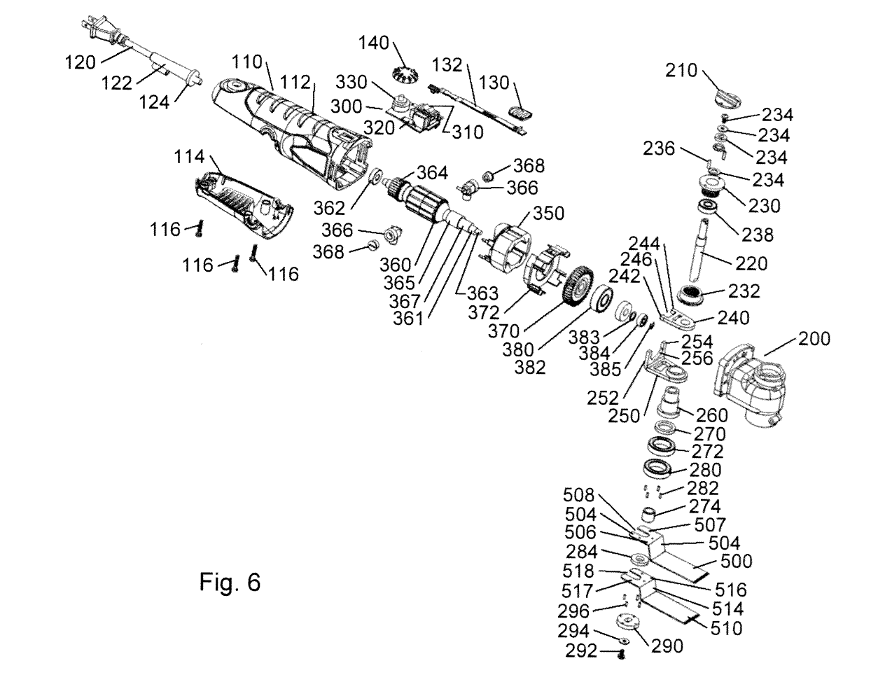

Referring again to FIGS. 1-7, the body 110 of the oscillating multi-tool is designed to enable a user to grasp the oscillating multi-tool during use. The configuration of the body is non-limiting. The body can optionally include a rotate button that enables a portion of the body to be twisted and/or pivoted; however, this is not required. The body can be a single piece unit or include one or more secondary components that are connectable to the body. As illustrated in FIG. 6, a bottom unit 114 is designed to be connected to the body by one or more connection arrangements such as, but not limited to, screws 116. As can be appreciated, an alternative or additional connection arrangement can be used (adhesive, solder bond, melt bond, weld bead, rivet, nut and bolt, snap lock arrangement, clamp arrangement, etc.).

The body can optionally include one or more gripping surfaces 112 to facilitate in the griping of the oscillating multi-tool by the user. The type of material, location of the gripping surface on the body, the style of the gripping surface, and the configuration of the gripping surface are non-limiting. For example, all or a portion of the front of the body of the oscillating multi-tool can be covered with or include a soft gripping material and/or other type of gripping material. Such gripping material can be used to facilitate in grasping and/or guiding the oscillating multi-tool during use and/or to reduce vibration to the user during the use of the oscillating multi-tool. The body can also or alternatively include one or more non-smooth surfaces (e.g., ribs, indents, roughened surfaces, etc.) to facilitate in the gipping of the body of the oscillating multi-tool; however, this is not required.

The oscillating multi-tool can be powered by a battery, a power cord, etc. When the oscillating multi-tool is powered by a battery, the battery can be a rechargeable battery, a removable battery, etc.; however, this is not required. The one or more batteries, when used, can be located in the body of the oscillating multi-tool. When the oscillating multi-tool is powered by a power cord 120, the power cord is generally connected to the back end of the body; however, this is not required. A strain relief 122 can be used to secure the power cord to the body and to reduce damage to the power cord near the body; however, this is not required. As can be appreciated, the size, shape and location of the one or more batteries, when used, are non-limiting.

The body generally includes a power button 130 that is used to activate the one or more electric motors that are located partially or fully within the body of the oscillating multi-tool. The size, location and orientation of the one or more motors in the body of the oscillating multi-tool are non-limiting. The speed at which the one or more motors operate is also non-limiting. The power button is generally a slide switch. As can be appreciated, other or additional types of activation arrangements (e.g., depressible button, etc.) can be used to activate/deactivate the one or more motors in the body of the oscillating multi-tool. As can be appreciated, the size, shape, operation, and location of the power button on the body of the oscillating multi-tool are non-limiting. As illustrated in FIG. 1, the power button is located on the top of the body near the front end of the body.

The power button can be designed to vary the speed of the one or more electric motors based on the amount the power button is moved and/or depressed by the user; however, this is not required. As such, the oscillating multi-tool can be a multi-speed oscillating multi-tool or a single speed oscillating multi-tool. A lock button can optionally be positioned on the body of the oscillating multi-tool to prevent the activation of the power button and/or to lock the power button in an “on” position or an “off” position. As can be appreciated, the size, shape, operation, and location of the lock button are non-limiting. As illustrated in FIG. 1, the body of the oscillating multi-tool can optionally include a speed dial 140. The speed dial can be used to select various motor speeds. The number of selection speeds for the speed dial is non-limiting. As illustrated in FIG. 1, six (6) speed selections can be selected by the speed dial; however, it can be appreciated that a larger or smaller number of speed selections can be selected by the speed dial. As can be appreciated, the size, shape and location of the speed dial, when used, are non-limiting. As illustrated in FIG. 1, the speed dial is located on the top surface of the body near the back end of the body; however, it can be appreciated that the speed dial can be located on other regions of the body. As can also be appreciated, the speed dial can be in other forms (e.g., depressible switch, slidable switch, etc.).

The body of the oscillating multi-tool can include a stroke adjustment button; however, this is not required. The oscillating multi-tool can be designed to be a single stroke oscillating multi-tool or a multi-stroke oscillating multi-tool. When the oscillating multi-tool is a multi-stroke oscillating multi-tool, a button, knob, switch or the like can be used to select the available stroke options of the oscillating multi-tool. The size, shape, operation and location of the button, knob, switch, etc. on the body of the oscillating multi-tool are non-limiting. The body can optionally include one or more vent openings 150 to allow for air flow into and/or out of the interior of the body to enable cooling of one or more components (e.g., motor, etc.) in the body. The number, shape and/or location of the one or more vent openings on the body of the oscillating multi-tool are non-limiting.

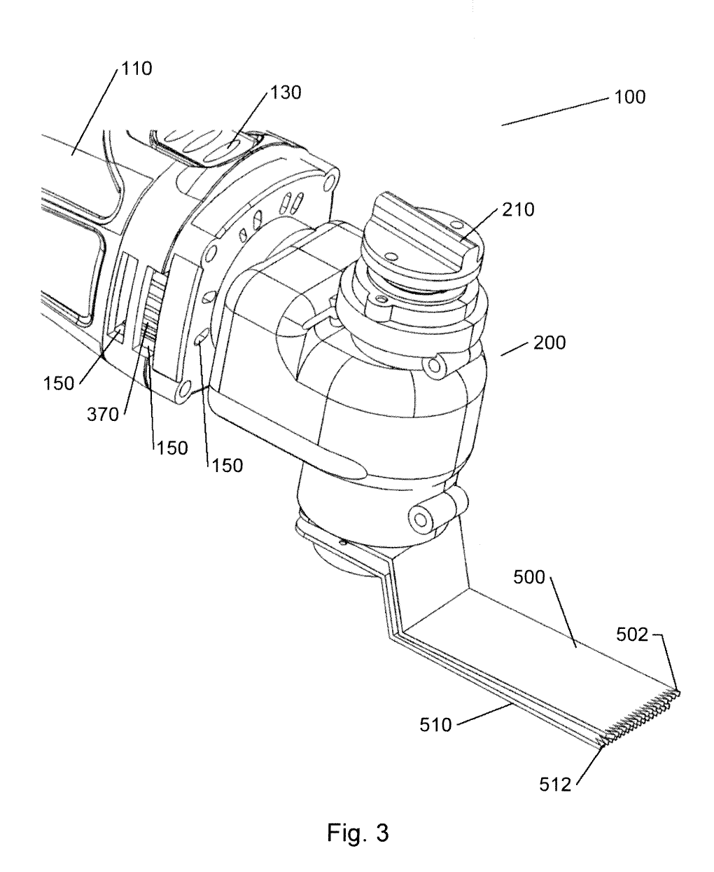

A tool mount housing 200 is connected to the front end of body 110 of the oscillating multi-tool. The tool attachments are generally connected to the tool mount housing. Non-limiting tool attachments include an E-cut blade(s), a scraper blade(s), a sanding pad(s), a wood saw blade(s), a wood/metal saw blade(s), a grout blade(s), a plunge blade(s), a segmented blade(s), etc. The one or more tool attachments can be connected to the tool mount housing in a variety of ways. As illustrated in FIG. 1, two scraper blades 500, 510 are connected to the tool mount housing. When two tool attachments such as, but not limited to, scraper blades 500, 510 are connected to the tool mount housing, the two tool attachments are designed to oscillate in opposite directions to one another during the operation of the oscillating multi-tool. As illustrated in FIG. 3, two blades 500, 510 include a plurality of teeth 502, 512 at the front end of the blades. As previously mentioned, various types of blades can be used with the oscillating multi-tool. Different types of blades can be configured to facilitate in the cutting of different types of material. Not only can the general configuration of the blades be specially configured, the tooth configuration on the blades can also be customized for use in cutting different types of materials.

The oscillating multi-tool of the present invention can be used with one or two blades. When two blades are used, the blades may or may not be connected together. One or both blades can include a spacer arrangement that maintains the distance of the blades from one another during the operation of the oscillating multi-tool; however, this is not required. Many arrangements can be used for the spacer arrangement (e.g., rib, pin, roller bearing, etc.), when used on one or both blades.

The configuration of the teeth on the blades is non-limiting. The blades may or may not include cutting teeth. One or more teeth on the blades can angle outwardly; however, this is not required. In one non-limiting blade, every tooth angles outwardly. In another non-limiting blade, every other tooth angles outwardly. In still another non-limiting blade, every third or fourth tooth angles outwardly. As can be appreciated, the teeth can be configured on one or both blades so that the teeth angle outwardly such that a wave or snake-like pattern is formed by the teeth along all or a portion of the longitudinal length of the blade; however, this is not required. The degree that the one or more teeth angle outwardly is non-limiting. The degree that different teeth angle outwardly can be the same or different on each blade. The teeth configuration and teeth angle on each of the blades can be the same or different along the longitudinal length of the blades.

One or more teeth on the one or more blades can include a first and second facing side cutting edge for cutting in both side to side movements of the blades when the blades are oscillated. The teeth can have a general V-shaped profile; however other profiles can be used (e.g., W profile, inverted V-shape, inverted W-shape, M-shape, etc.). The tips of the teeth can be rounded; however, it can be appreciated that the tips of one or more of the teeth can be pointed. The side edges of the teeth can be tapered; however, this is not required. The taper on the front and/or rear side edge of one or more teeth on one or both blades can be used to 1) improve the cutting of material by one or both blades, and/or 2) create an inward force that causes one or both blades to move toward one another during the cutting of material; however, this is not required. The taper, when used, can be on the front portion of the tooth, the back portion of the tooth, or on both the front and back portion. The taper, when used, is generally located on the outer side of the tooth; however, it can be appreciated that the taper can be located on the inner side of the tooth or on both the inner and outer side of the tooth. The top edge of one or more teeth can also include tapered surfaces. The top of the teeth can be generally flat; however, it can be appreciated that the profile of the top of the teeth can have other profiles (e.g., V shaped, W shaped, inverted V-shape, inverted W-shape, M-shape, etc.). The height or length of the teeth on the blades can be the same or different.

In one non-limiting tooth configuration for one or more of the blades, one or more of the teeth have a top edge that is both angled and tapered; however, this is not required. As can be appreciated, the top edge or surface of one or more teeth can have an angled surface, a tapered surface, or both an angled and a tapered surface. The angle of the angled surface and the angle of the tapered surface are non-limiting. The angled and/or tapered surface can be continuous along the length of the tooth; however, this is not required. The angle of the angled and/or tapered surface can be constant or vary along the length of the tooth.

In one non-limiting configuration, the angled and/or tapered surface, when used, is selected to cause one or both blades to move toward one another when cutting through a material; however, this is not required. Such a configuration can result in the elimination of a blade connector. One or more inner surfaces of the blades can include one or more blade separators to maintain the spacing of the blades from one another during the operation of the blade; however, this is not required. The number and/or shape of the blade separators, when used, are non-limiting.

Intermediate teeth can be positioned between the main teeth of the blades. The intermediate teeth, when used, can be taller or shorter than the main teeth.

The teeth shape, tapered surface and/or the outward angling of one or more teeth on one or both blades are generally used to 1) improve the cutting of material by one or both blades, 2) cause the two blades to be pushed together during the cutting of material, 3) reduce the wear on one or both blades when cutting material, 4) reduce the vibration and/or jerking action caused by one or both blades during the cutting of material, 5) enable one or both blades to cut material on both side to side motions of the one or both blades, 6) balance the cutting action of the two blades, 7) improve the accuracy of the cut in a material by the two blades, 8) form smoother cuts through a material, 8) reduce the fatigue on the user during the cutting of material, and/or 9) facilitate in the removal of cut material during the cutting of the material by one or both blades. As can be appreciated, the tapered surface and/or the outward angling of one or more teeth on one or both blades can have other or additional functions.

The material used to form the blades is non-limiting. Generally, the length, thickness, height (width), shape and material of the two blades are the same; however, this is not required. The height (width) of one or both blades can be constant or vary along the longitudinal length of the saw blades.

As illustrated in FIG. 1, a wing nut 210 is positioned on the tool mount housing to enable a user to connect and disconnect one or more tool attachments to the tool mount housing. The operation of this connection arrangement will be described in more detail below. The wing nut is positioned on the top region of the tool mount housing; however, it can be appreciated that the wing nut can be positioned on other regions of the tool mount housing. Referring now to FIGS. 8 and 9, a depressible mount button 212 is positioned on the tool mount housing to enable a user to connect and disconnect one or more tool attachments to the tool mount housing. The operation of this connection arrangement will be described in more detail below. The depressible mount button is positioned on the top region of the tool mount housing; however, it can be appreciated that the wing nut can be positioned on other regions of the tool mount housing. As can be appreciated, the size, shape, operation, and location of the arrangement used to connect and disconnect one or more tool attachments to the tool mount housing are non-limiting. As can be appreciated, may other arrangements can be used to enable a user to connect and disconnect one or more tool attachments to the tool mount housing.

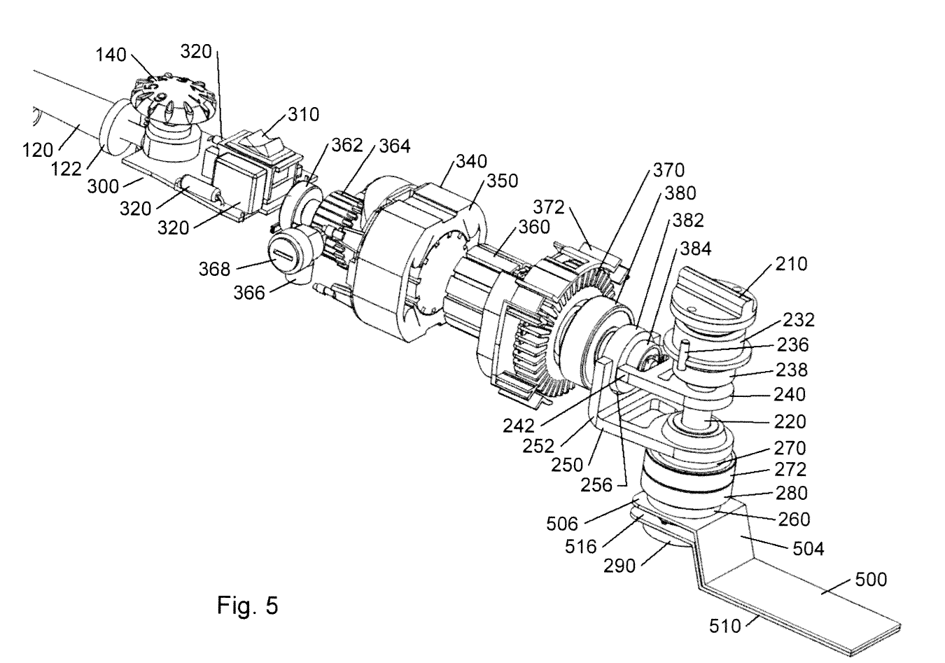

Referring now to FIGS. 5-7, one non-limiting drive and gear arrangement used to cause one or more tool attachments to oscillate during the operation of the oscillating multi-tool is illustrated. The gear arrangement used to cause one or both tool attachments to oscillate is non-limiting. The gear arrangement can be designed to cause one or both tool attachments to always or periodically oscillate in opposite directions during the operation of the oscillating multi-tool. When two tool attachments are oscillated by the oscillating multi-tool, generally both tool attachments move in parallel paths or planes; however, this is not required.

As illustrated in FIGS. 5 and 6, the end portion of cord 120 is fitted into a relief 122. The front end of the relief includes a larger diameter portion 124 which is positioned in the body 110 of the oscillating multi-tool so as to secure the relief to the body. The relief is generally formed of a flexible material. The end of the cord is connected to a motor control unit 300. The speed dial is illustrated as connected to a speed controller 330 on the motor control unit. The speed dial can be designed to regulate the amount of current that is fed to motor 340 to thereby control the speed of the motor. The motor control unit also includes an activation switch 310 that is designed to allow or terminate the flow of current to the motor so as to activate and deactivate the operation of the motor. The motor control unit can optionally include other electronic components 320 such as resistors, capacitors, transistors, and the like to control the operation, speed and/or rotational direction of the motor. As illustrated in FIG. 5, the motor control unit is positioned generally at the back portion of body 110; however, this is not required. As illustrated in FIG. 1, power button 130 is located at the front portion of body 110. A switch slide arm 132 can be used to mechanically connect the power button 130 to the activation switch 310 so that movement of the power button by a user causes the activation switch 310 to switch between an activation and non-activation position. As can be appreciated, other mechanical or electronic arrangements can be used to cause the activation switch 310 to switch between an activation and non-activation position when the power button 130 is moved or depressed by a user.

The motor control unit is electrically connected to motor 340. Motor 340 is used to drive the novel gearing in the gear arrangement to cause one or two tool attachments to oscillate when the motor is operating. The motor 340 includes a housing 350 that generally includes a magnet, brushes and/or winding to cause an armature 360 to rotate. At one end of the armature is an end bearing 362. The armature can include commentator 364. The central axis of the armature generally lies in a plane that is parallel to the longitudinal axis of body 110; however, this is not required. A brush housing 366 that includes a removable cover 368 can be optionally used to enable a user to repair and/or replace brushes on the armature. A motor cooling fan blade 370 can be optionally connected to the armature on surface 365 to cool the motor during operation. A fan housing 372 can optionally be used to partially encircle the fan blade to provide protection to the fan blade. A front bearing 380 can be positioned on surface 367 of the armature to facilitate in the rotation of the armature and/or to maintain the fan blade on the armature. The outer surface of surfaces 365 and 367 are generally positioned about the central axis of the armature; however, this is not required.

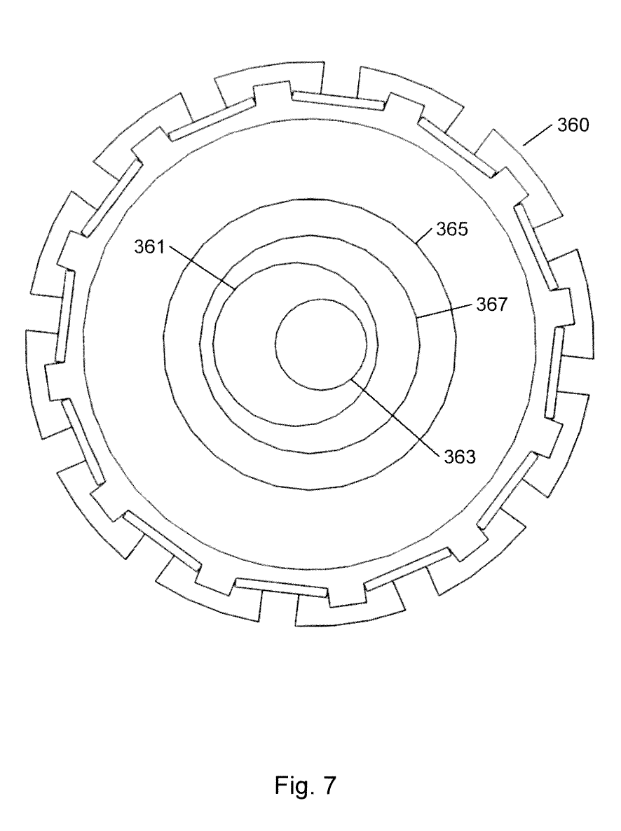

The front end portion of the armature has two eccentric surfaces 361, 363. The eccentric positioning of the surfaces is best illustrated in FIG. 7. The central axis of each of the eccentric surfaces is off center from the central axis of the armature. Also, the central axis of each of the eccentric surfaces is not a common axis, and each central axis of the eccentric surfaces is positioned about 180° from one another relative to the central axis of the armature. The outer circumference of eccentric surface 361 is generally different from the outer circumference of eccentric surface 363; however, this is not required. Generally, the outer circumference of eccentric surface 361 is larger than the outer circumference of eccentric surface 363; however, this is not required. As illustrated in FIG. 7, the outer circumference of surfaces 365, 367 are different from one another and from the outer circumference of eccentric surfaces 361, 363; however, this is not required.

A first bearing 382 is designed to be positioned on eccentric surface 361 and a second bearing 384 is designed to be positioned on eccentric surface 363. A washer 383 and lock E-clip 385 can optionally be used to secure bearings 382, 384 on the armature and/or maintain a spacing between two bearings 382, 384; however, this is not required. During the operation of the motor, the motor causes the armature to rotate about the central axis of the armature. The rotation of the armature causes bearings 382, 384 to move about the central axis of the armature, but to rotate about the respective central axes of eccentric surfaces 361, 363. As will be explained in more detail below, the novel configuration of the front end of the armature causes two tool attachments that are connected to the tool mount housing 200 to oscillate in opposite directions during the operation of motor 340.

The gearing arrangement in tool mount housing 200 is designed to interact with bearings 382, 384 and to convert the movement of bearings 382, 384 into the oscillating movement of the one or more tool attachments connected to the tool mount housing. The tool mount housing includes a mount pin 220 that runs along the vertical length of the tool mount housing. The central axis of the mount pin is generally positioned non-parallel (e.g., perpendicular, etc.) to the central axis of armature 360. A first and second threaded collar 230, 232 is positioned on the upper portion of the mount pin. A connection arrangement such as a screw 232 secures threaded collar 230 to the top end of the mount pin. One or more rings, screws and/or washers 234 can be positioned between the top of threaded collar and wing nut 210; however, this is not required. Connection pins 236 can be used to connect the wing nut to threaded collar 230; however, this is not required. A bearing 238 can be positioned on the mount pin and below threaded collar 230; however, this is not required.

A first yoke 240 is connected to mount pin 220. The first yoke has two bearing arms 242, 244 that extend outwardly from the front end of the first yoke. Generally, the two bearing arms lie in a plane that is generally parallel to the longitudinal axis of the first yoke; however, this not required. A bearing slot 246 is formed between the two bearing arms 242, 244. As best illustrated in FIG. 9, the two bearing arms are positioned about second bearing 384 and a portion of the second bearing 384 is positioned in bearing slot 246.

A second yoke 250 is positioned below the first yoke; however, this is not required. The second yoke is mounted to a mount collar 260. The mount collar is positioned about mount pin 220, but is not rotatably connected to the mount pin. As such, the mount collar and mount pin can rotate in different directions to one another. The second yoke includes two bearing arms 252, 254 that extend upwardly from the front end of the second yoke. Generally, the two bearing arms lie in a plane that is generally nonparallel (e.g., perpendicular, etc.) to the longitudinal axis of the second yoke; however, this not required. Generally, the bearing arms of the second yoke lie in a plane that is non-parallel to the plane of the bearing arms of the first yoke; however, this is not required. A bearing slot 256 is formed between the two bearing arms 252, 254. The bearing slot has a generally curvilinear surface; however, this is not required. As best illustrated in FIG. 9, the two bearing arms 252, 254 are positioned about first bearing 382 and a portion of the first bearing 382 is positioned in bearing slot 256. The curvilinear surface of bearing slot 256 is similar to the shape of at least a portion of the outer surface of the first bearing 383 that is positioned in bearing slot. Generally, at least 40%, typically about 40%-100%, and more typically about 50%-100 of the outer perimeter of the first bearing is encircled by the bearing slot and two bearing arms of the second yoke; however, this is not required. As illustrated in FIG. 9, generally, less than 60%, typically less than 50%, and more typically about 5%-40% of the outer perimeter of the second bearing is encircled by the bearing slot and two bearing arms of the first yoke; however, this is not required.

One or more bearings and bushings 270, 272, 274 can optionally be positioned below mount collar 260. The first blade mount collar 260 generally includes one or more blade connectors to engage with blade 500. As illustrated in FIG. 6, the connectors can be in the form of one or more pins 282; however, this is not required. Blade 500 is illustrated as including an angled flange 504 and amount flange 506. The mount flange includes one or more openings 507, indents, etc. that are designed to receive a portion of pins 282 to thereby connect the blade to first blade mount collar 260. The mount flange also includes a slot 508 to enable the mount flange to be positioned about and move relative to the bottom portion of mount pin 220. A washer 284 can optionally be positioned between blades 500, 510.

A second blade mount collar 290 is connected to the bottom of mount pin 220. A screw 292 and washer 294 can be used to secure the second blade mount collar 290 to the bottom of mount pin 220; however, other or additional arrangements can be used. The second blade mount collar 290 generally includes one or more blade connectors to engage with blade 510. As illustrated in FIG. 6, the connectors can be in the form of one or more pins 296; however, this is not required. Blade 510 is illustrated as including an angled flange 514 and a mount flange 516. The mount flange includes one or more openings 517, indents, etc. that are designed to receive a portion of pins 296 to thereby connect the blade to second blade mount collar 290. The mount flange also includes a slot 518 to enable the mount flange to be positioned about the bottom portion of mount pin 220.

During the operation of motor 340, armature 360 is caused to rotate in a clockwise or counterclockwise direction. During the rotation of the armature, the eccentric bearings 382, 384 move in an elliptical path about the central axis of the armature. The elliptical path of the eccentric bearings 382, 384 causes the yokes that engage the respective eccentric bearings to oscillate. The oscillating movement of yoke 240 causes mount pin 220 to oscillate, which in turn causes second blade mount collar 290 to oscillate, which in turn causes a tool attachment such as blade 510 that is connected to second blade mount collar 290 to oscillate. The oscillating movement of yoke 250 causes mount collar 260 to oscillate, which in turn causes a tool attachment such as blade 500 to oscillate. The configuration of the eccentric surfaces 361, 363 on the armature, the size of bearings 382, 384, the configuration of yokes 240, 250, and the configuration of mount collar 260 and mount pin 220 can be selected to obtain the stroke size of each of the tool attachments connected to the mount collars, and the relative movement of the tool attachments to each other during the operation of the motor. Generally, the oscillating multi-tool is designed to cause two tool attachments (e.g., blades 500 & 510, etc.) that are connected to the oscillating multi-tool to oscillate at the same stroke length and in opposite directions from one another; however, this is not required. The stroke length of each of the tool attachments is generally about 1°-5° of rotation (e.g., 1.4°, 2.8°, 3.2°, etc.). Generally, the oscillating multi-tool has a single stoke length; however, it can be appreciated that the oscillating multi-tool can be designed to enable a user to select different stroke lengths; however, this is not required.

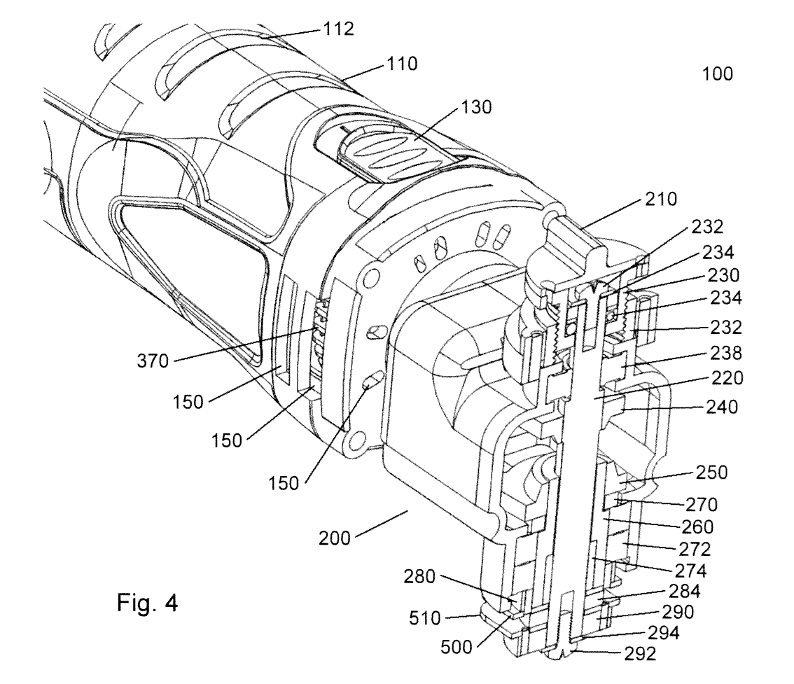

As best illustrated in FIGS. 4 and 9, two different quick disconnect arrangements for the tool attachments can be used. As can be appreciated, many other quick disconnect arrangements for the tool attachments can be used. Referring now to FIG. 4, when the wing nut 210 is rotated in a first direction, the rotation of the wing nut causes threaded collar 230 to unthread from threaded collar 232 thereby causing the top of each of the threaded collars to more away from one another. Such movement causes mount pin 220 to move downwardly thereby causing mount collar 290 to separate from mount collar 260. The separation of the two mount collars enables one or both tool attachments to be connected to one or both mount collars or removed from one or both mount collars. When the wing nut is rotated in a direction opposite the first direction, the rotation of the wing nut causes threaded collar 230 to thread together to threaded collar 232 thereby causing the top of each of the threaded collars to move together. Such movement causes mount pin 220 to move upwardly thereby causing mount collar 290 to move closer to mount collar 260. Such movement of second mount collar toward the first mount collar causes one or both tool attachments to be secured to one or both mount collars.

Referring now to FIG. 9, when depressible mount button 212 is pressed downwardly by a user, the downward movement of the depressible mount button causes a biasing arrangement such as spring 214 to compress and enables bearing 216 to move upwardly into the interior of depressible mount button. The downward movement of the depressible mount button causes the depressible mount button to engage the top of mount pin 220 thereby causing mount pin 220 to move downwardly and thereby causing mount collar 290 to separate from mount collar 260. The separation of the two mount collars enables one or both tool attachments to be connected to one or both mount collars or removed from one or both mount collars. When the depressible mount button 212 is released by the user, the biasing arrangement causes the depressible mount button to move upwardly. Such upward movement causes bearing 216 to engage a bottom region of the depressible mount button and thereafter cause the mounting pin to move upwardly. Such upward movement of the mount pin 220 causes mount collar 290 to move closer to mount collar 260. Such movement of second mount collar toward the first mount collar causes one or both tool attachments to be secured to one or both mount collars.

The two quick disconnect arrangements described above are non-limiting configurations fora tool-less blade removal system that can be used with the oscillating multi-tool. As can be appreciated, a quick disconnect arrangement is not required for use on the oscillating multi-tool. When a quick disconnect arrangement is not used, the one or more tool attachments can be connected/disconnected from the tool mount housing 200 by use of washers, hex screws, etc. which require tools (e.g., screw driver, pliers, wrench, etc.) to remove and/or attach one or both tool attachments to the tool mount housing 200 of the oscillating multi-tool. The oscillating multi-tool can include alight or laser that can be used to guide the tool attachments during the cutting, etc. of material and/or illuminate the material during the cutting, etc. of the material. The light or laser can be activated by a switch that is located on the body of the oscillating multi-tool. In one non-limiting arrangement, the switch is positioned beneath the surface of the body and is designed to be activated and cause the light or laser to illuminate when a user grasps the body and to turn off when the user releases the body; however, this is not required. Alternatively, a switch can be positioned on the body to enable a user to manually activate/deactivate the light or laser. As can be appreciated, the size, shape, operation, and location of switch are non-limiting. As can be appreciated, the oscillating multi-tool can include a light and laser, multiple lights, and/or multiple lasers.

It will thus be seen that the objects set forth above, among those made apparent from the preceding description, are efficiently attained, and since certain changes may be made in the constructions set fourth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

1. An oscillating multi-tool for cutting, scraping, sanding, or grinding of material, said oscillating multi-tool comprising a body, a drive system and a gear arrangement that is at least partially positioned in said body, said drive system and said gear arrangement designed to cause first and second tool attachments to partially or fully oscillate in opposite directions, said gear arrangement connected or interconnected to first and second tool connectors, said first tool attachment connected to said first tool connector, said second tool attachment connected to said second tool connector, said gear arrangement causing said first and second tool connectors to move when said drive system is activated to thereby cause said first and second tool attachments to partially or fully oscillate in opposite directions relative to one another.

2. The oscillating multi-tool as defined in claim 1, wherein said drive system includes a single drive axle that can be rotated clockwise and/or counterclockwise, said single drive axle engagable with said gear arrangement, said rotation of said single drive axle causing said first and second tool connectors to move to thereby cause said first and second tool attachments to partially or fully oscillate in opposite directions relative to one another.

3. The oscillating multi-tool as defined in claim 1, wherein said gear arrangement including an armature that includes one or more eccentric bearing surfaces to cause said first and second tool attachments to partially or fully oscillate in opposite directions relative to one another.

4. The oscillating multi-tool as defined in claim 2, wherein said gear arrangement including an armature that includes one or more eccentric bearing surfaces to cause said first and second tool attachments to partially or fully oscillate in opposite directions relative to one another.

5. The oscillating multi-tool as defined in claim 2, wherein said single drive axle is positioned generally non-parallel to an oscillating axis of said first and second tool attachments.

6. The oscillating multi-tool as defined in claim 4, wherein said single drive axle is positioned generally non-parallel to an oscillating axis of said first and second tool attachments.

7. The oscillating multi-tool as defined in claim 3, wherein said gear arrangement includes first and second yokes, said armature having first and second eccentric bearing surfaces, a first bearing connected to said first eccentric bearing surface, a second bearing connected to said second eccentric bearing surface, and first and second tool connectors, said first tool connector connected or interconnected to said first yoke, said second tool connector connected or interconnected to said second yoke, said first yoke including a bearing engagement surface that engages said first bearing, said second yoke including a bearing engagement surface that engages said second bearing, said first and second eccentric bearing surfaces off center from one another and off center from a central axis of said armature, said first bearing causing said first yoke to oscillate when said armature rotates, said second bearing causing said second yoke to oscillate when said armature rotates, said rotation of said armature causing said first and second tool attachments to partially or fully oscillate in opposite directions relative to one another.

8. The oscillating multi-tool as defined in claim 6, wherein said gear arrangement includes first and second yokes, said armature having first and second eccentric bearing surfaces, a first bearing connected to said first eccentric bearing surface, a second bearing connected to said second eccentric bearing surface, and first and second tool connectors, said first tool connector connected or interconnected to said first yoke, said second tool connector connected or interconnected to said second yoke, said first yoke including a bearing engagement surface that engages said first bearing, said second yoke including a bearing engagement surface that engages said second bearing, said first and second eccentric bearing surfaces off center from one another and off center from a central axis of said armature, said first bearing causing said first yoke to oscillate when said armature rotates, said second bearing causing said second yoke to oscillate when said armature rotates, said rotation of said armature causing said first and second tool attachments to partially or fully oscillate in opposite directions relative to one another.

9. The oscillating multi-tool as defined in claim 7, wherein said bearing engagement surface of said first yoke surrounding at least 50% of an outer perimeter of said first bearing, said bearing engagement surface of said second yoke surrounding at least 50% of an outer perimeter of said second bearing, said bearing engagement surface of said first yoke lying in a different plane from said bearing engagement surface of said second yoke.

10. The oscillating multi-tool as defined in claim 8, wherein said bearing engagement surface of said first yoke surrounding at least 50% of an outer perimeter of said first bearing, said bearing engagement surface of said second yoke surrounding at least 50% of an outer perimeter of said second bearing, said bearing engagement surface of said first yoke lying in a different plane from said bearing engagement surface of said second yoke.

11. The oscillating multi-tool as defined in claim 1, wherein said first and second tool attachments are positioned closely adjacent to one another so as to form a single cut in a material as said first and second tool attachments partially or fully oscillate in opposite directions relative to one another during the cutting of the material.

12. The oscillating multi-tool as defined in claim 10, wherein said first and second tool attachments are positioned closely adjacent to one another so as to form a single cut in a material as said first and second tool attachments partially or fully oscillate in opposite directions relative to one another during the cutting of the material.

13. The oscillating multi-tool as defined in claim 1, said body including a light switch, said light switch designed to activate, deactivate, or combinations thereof a light, a laser, or combinations thereof that is positioned on said body of said oscillating multi-tool.

14. The oscillating multi-tool as defined in claim 12, said body including a light switch, said light switch designed to activate, deactivate, or combinations thereof a light, a laser, or combinations thereof that is positioned on said body of said oscillating multi-tool.

15. The oscillating multi-tool as defined in claim 13, wherein said light switch is positioned under and outer surface of said body and is designed to activate said light, said laser, or combinations thereof when a user grasps said body of said oscillating multi-tool when cutting material with said oscillating multi-tool.

16. The oscillating multi-tool as defined in claim 14, wherein said light switch is positioned under and outer surface of said body and is designed to activate said light, said laser, or combinations thereof when a user grasps said body of said oscillating multi-tool when cutting material with said oscillating multi-tool.

17. The oscillating multi-tool as defined in claim 1, including a tool attachment quick disconnect that is designed to detach, to connect or combinations thereof said first tool attachment, said second tool attachment, or combinations thereof from a first tool connector, a second tool connector, or combinations thereof on said oscillating multi-tool.

18. The oscillating multi-tool as defined in claim 16, including a tool attachment quick disconnect that is designed to detach, to connect or combinations thereof said first tool attachment, said second tool attachment, or combinations thereof from said first tool connector, said second tool connector, or combinations thereof on said oscillating multi-tool.

19. The oscillating multi-tool as defined in claim 1, wherein said body includes a handle arrangement, said handle arrangement designed to pivot relative to a longitudinal axis of said body, rotate relative to said longitudinal axis of said body, or combinations thereof.

20. The oscillating multi-tool as defined in claim 18, wherein said body includes a handle arrangement, said handle arrangement designed to pivot relative to a longitudinal axis of said body, rotate relative to said longitudinal axis of said body, or combinations thereof.
